(19) United States
(12) Patent Application Publication
(10) Pub. No.: US 2012/0072298 A1
(43) Pub. Date: Mar. 22, 2012

(54) Method and System for Facilitating Automated Real Time Negotiating and Bargaining Followed by Purchase of Merchandize

(76) Inventors: Srinivasan Ramanujam, Santa Cruz, CA (US); Devendra Joshi, San Jose, CA (US)

(21) Appl. No.: 13/214,075

(22) Filed: Aug. 19, 2011

Related U.S. Application Data
(60) Provisional application No. 61/384,307, filed on Sep. 19, 2010.

(51) Int. Cl. G06Q 30/00

(52) U.S. Cl. 705/26.3; 705/26.1; 705/27.1

(57) ABSTRACT

The preferred embodiment of the present invention is directed to a method, and system to automate real time price negotiation and bargaining followed by actual purchase of merchandize or service at a retail location. The merchandize can range from real goods and/or service(s) available at any store or retail outlet to entertainment such as movies, concerts, sporting events and others.

### RELATED APPLICATIONS

This is a continuation-in-part non provisional utility patent application of U.S. provisional patent application Ser. No. 61/384,307 filed on Sep. 19, 2011, entitled “Method, System and Apparatus for Facilitating Automated, Real-Time Negotiating and Bargaining Followed by Purchase of Merchandize”.

### BACKGROUND

The present invention is in the general field of automating of bargaining for goods and services that leads to the optimum sales price acceptable for both the buyer and seller. More particularly, the present invention is in the technical field of electronic automation enabling real-time back and forth negotiations to arrive at a price for in-store purchase using any of the electronic devices including mobile/smart phones, tablets or i-Pad or similar devices, net books and other mobile computing devices, desktop, laptop and other computing devices, or telephones. Buyers and sellers can converge, when the buyer is ready, to a final price, in real-time, in an automated fashion without human interaction, at any store.

Bargaining or haggling is a type of negotiation in which the buyer and seller of a good or service do not agree on the initial price and eventually come to an agreement. (Ref: http://en.wikipedia.org/wiki/Bargaining). From a retailer's standpoint, they can choose to sell at posted prices or allow bargaining: a bargaining strategy has the advantage that it allows the retailer to price discriminate between different types of customer. In some markets, such as those for automobiles and expensive electronic goods, firms post prices but are open to haggling with consumers.

Today, for those who want to get the best deal, the Internet is filled with a large mass of information on any product, including its availability, pricing comparison, rating and review, etc., helping buyers develop strategies to get the best deal or discount price and to place the order for the product on the web. Internet shopping (e.g.: Amazon.com, Buy.com) sites and auction sites (ex: ebay.com) facilitate how the products can be ordered, and be delivered subsequently.

Despite the big presence of discount shopping in the internet, consumers continue to shop retail. The size of the retail business in the US alone is a whopping $4.13 Trillion (U.S. Census Bureau 2009) and this figure include most retail sales categories such as discount stores, department stores, grocers, and specialty stores. Entertainment spending including spending on movies, concerts, sporting events and others should belong to this category as well.

Customers shop retail for many reasons including convenience, the ability to touch and feel and experience the product prior to buying and the instant gratification of purchase. Another big advantage is the ease of return of purchased goods. The real savvy consumers are finding that they can dicker on prices, not just on clearance items or big-ticket products like televisions but also on lower-cost goods like cameras, audio speakers, couches, rugs and even clothing (New York Times Mar. 23, 2008). But a large majority of customers, for various reasons, prefer not to haggle on prices. Often times, they are unaccustomed to bargaining. They might feel empowered to bargain if they are given a suitable tool and they don't have to deal directly with the salespeople or store clerks face to face.

One form of bargaining available in the internet for goods and services is name-your-own-price (NYOP) options such as Priceline.com. Airlines tickets, rental car, hotels are some of the examples of NYOP services. Under the NYOP format, the seller sets a hidden threshold price, consumers bid for units of its product, and any bid that exceeds this threshold price is accepted (Scott Fay, Competitive Reasons for the Name-Your-Own-Price, Marketing Letters, September, 2009)

But these type of solutions offered on the web do not help customers who want to shop retail, make the purchase decision at the store, bargain and get the best discount and pay for purchase. Internet sites do provide on-line coupons for some goods, if available, as one way of obtaining some discount but they do not help in negotiating to get the best price and in some cases even over and above the coupons if they are available.

Other options offered by some of the prior art (Sato, Pub. No US 2001/0025257A1; Khan, Pub. No US2004/0220884A1; Burchetta et al., Pub. No. US 2008/0126254A1) do not address how to get the best price for in-store purchase.

### BRIEF SUMMARY OF THE INVENTION

The preferred embodiment of the present invention is directed to a method, and system to automate real time price negotiation and bargaining followed by actual purchase of merchandize at a retail location. In short, the preferred embodiment of the present invention implements an electronic bargaining and negotiating system and method that generally comprises means for bargaining iteratively to identify what a willing buyer expects from a willing seller and what a willing seller expects from a willing buyer and means for executing a completed transaction in response to the willing buyer and the willing seller reaching a negotiated agreement upon what each one of them expects from the other. For the purpose of this invention, the merchandize can range from real goods and/or services which are available at any store or retail outlet to entertainment such as movies, concerts, sporting events and others.

When customers shop retail, they look at the merchandize and try and experience it, and compare similar products or brands and services available at the store. This is true whether they are a purchasing big or small ticket item—from electronic goods, furniture, appliances, clothes, fashion and cosmetics to even books—prior to deciding. Bargaining for an entertainment or recreational event falls in this category as well. When buyers have finally decided and are ready to purchase, they now will have a solution available to help them with the bargaining and consummate the purchase with ease using one of the many communication tools. The tools offered here can enable buyers to negotiate and obtain, in an automated manner, the best deal they could get from the vendor.

More particularly, in one preferred method, using a plurality of texting-based communication using mobile devices, including cell phones, mobile phones, smart-phones, laptops, tablets, computers and others, to access and connect to an automated negotiation and bargaining system using any mode of connectivity including wireless, internet or similar connectivity, the method comprises the steps of: (1) identifying and confirming any specific merchandize or merchandizes a buyer desires to purchase, including but not limited to retail goods, entrance to entertainment events and sporting and recreational events, through a sequence of one or more interactions with the bidding servers; (2) entering an offer price for the above merchandize/s by a buyer; (3) responding with an acceptable price by a seller, as identified by the system; (4) going through one or more rounds of offers by buyer and responses by seller until an acceptable price is established; (5) accepting and confirming the offer price by the buyer; and (6) completing the payment and execute the transaction via secured connectivity obtain, by the buyer, a plurality of codes, including but not limited to one-time-use only bar codes, letters or numbers or combination, to be shown to the retail vendor in exchange for the goods and/or services.

In this preferred embodiment, each of the above-mentioned transactions takes place in real-time, at or near where the merchandize is kept, including but not limited to a store or a place of business. Also it should be noted that such agreement to purchase can take place at a remote location, including but not limited to the buyer's place of residence, and the buyer collects the merchandize later.

In another preferred method, using a plurality mobile electronic devices including but not limited to mobile phones, smart phones, portable computers, net books, tablets, and using a plurality of connectivity including but not limited to wireless, WiFi, Internet connectivity, generally includes the steps of: (1) downloading to a plurality of electronic devices, a program and user interface (UI) (“App”) to enable the electronic devices to connect to an automated negotiation and bargaining system; (2) accessing and connecting to an automated negotiation and bargaining system using any mode of connectivity including wireless, WiFi and internet or similar connectivity; (3) identifying and confirming any specific merchandize or merchandizes a buyer desires to purchase, including but not limited to retail goods, entrance to entertainment events and sporting and recreational events, through a sequence of one or more interactions with the bidding servers; (4) entering an offer price for the above-mentioned merchandize by the buyer; (5) responding with an acceptable price by a seller, as identified by the system; (6) going through one or more rounds of offer by the buyer and response by the seller until an acceptable price is established; (7) accepting and confirming by the buyer the offer price; and (8) completing the payment and execute the transaction via secured connectivity obtained by the buyer, a plurality of codes, including but not limited to one time use only bar codes, letters or numbers or combination, to be shown to the retail vendor, such as checkout counter, in exchange for the goods and/or services.

In this second preferred method, each of the above-mentioned transactions take place, near real-time, at or near where the merchandize is kept, including but not limited to a store or place of business. Moreover, each agreement to purchase can take place at a remote location, including but not limited to the buyer's place of residence, and the buyer collects the merchandize later.

In still yet another preferred method, using a plurality electronic devices, including but not limited to desktop computers, laptops, net books, tablets and using a plurality of connectivity including but not limited to wired or wireless internet connection, to download, to a plurality of electronic devices, a program and user interface (UI) to enable the electronic devices to connect to an automated negotiation and bargaining system, the method generally includes the following steps: (1) accessing and connecting the electronic devices using the UI to an automated negotiation and bargaining system; (2) identifying and confirming any specific merchandize or merchandizes a buyer desires to purchase, including but not limited to retail goods, entrance to entertainment events and sporting and recreational events, through a sequence of one or more interactions with the bidding servers; (3) entering an offer price for the above merchandize/s by the buyer; (4) responding with an acceptable price by the seller, as identified by the system; (5) going through one or more rounds of offer by the buyer and response by the seller until an acceptable price is established; (6) accepting and confirming by the buyer the offer price; and (7) completing the payment and executing the transaction via secured connectivity obtained by the buyer, a plurality of codes, including but not limited to one time use only bar codes, letters or numbers or combination, to be shown to the retail vendor, such as checkout counter, in exchange for the goods and/or services.

In this third preferred method, each transaction takes place, near real-time, at or near where the merchandize is kept, including but not limited to a store or place of business. Moreover, each agreement to purchase can take place at a remote location, including but not limited to the buyer's place of residence, and the buyer collects the merchandize later.

In yet another preferred method, using a plurality telephonic devices, including but not limited telephones, mobile phones to dial and connect the telephone using voice-recognition and/or touch button to an automated negotiation and bargaining system, the method generally includes the following steps: (1) identifying and confirming any specific merchandize or merchandizes a buyer desires to purchase, including but not limited to retail goods, entrance to entertainment events and sporting and recreational events, through a series of interactive commands and/or voice-recognition; (2) entering an offer price for the above-mentioned merchandize by a buyer; (3) responding with an acceptable price by a seller, as identified by the system; (4) going through one or more rounds of offer by buyer and response by the seller until an acceptable price is established; (5) accepting and confirming by the buyer the offer price; and (6) completing the payment and execute the transaction via secured connectivity obtained, by the buyer, a plurality of codes, including but not limited to letters or numbers or combination, to be shown to the retail vendor, such as checkout counter, in exchange for the goods and/or services.

In this last-mentioned preferred method each transaction takes place, near real-time, at or near where the merchandize is kept, including but not limited to a store, place of business. Also, in this preferred method, the agreement to purchase can take place at a remote location, including but not limited to the buyer's place of residence, and the buyer collects the merchandize later.

In another preferred embodiment, there is provided a system to facilitate automate real time price negotiation and bargaining followed by actual purchase of merchandize or service at a retail location; wherein the merchandize can range from real goods available at any store or retail outlet to entertainment such as movies, concerts, sporting events and others; the system generally including: (1) means for using a plurality of texting-based communication using mobile devices including cell phones, mobile phones, smart-phones, laptops, tablets, computers and others, to access and connect to an automated negotiation and bargaining system using any mode of connectivity including wireless, internet or similar connectivity; (2) means for identifying and confirming any specific merchandize or merchandizes a buyer desires to purchase, including but not limited to retail goods, entrance to entertainment events and sporting and recreational events, through a sequence of one or more interactions with the bidding servers; (3) means for entering an offer price for the above merchandize/s by a buyer; (4) means for responding with an acceptable price by a seller, as identified by the system; (5) means for going through one or more rounds of offers by buyer and responses by seller until an acceptable price is established; (6) means for accepting and confirming the offer price by the buyer; and (7) means for completing the payment and execute the transaction via secured connectivity obtain, by the buyer, a plurality of codes, including but not limited to one-time-use only bar codes, letters or numbers or combination, to be shown to the retail vendor in exchange for the goods and/or services.

In yet another preferred embodiment, there is provided a system to facilitate automated real time interactive price negotiation and bargaining followed by actual purchase of merchandize or service at a retail location; wherein the merchandize can range from real goods available at any store or retail outlet to entertainment such as movies, concerts, sporting events and others. In this preferred embodiment, the system generally includes (1) means for using a plurality of mobile electronic devices including but not limited to mobile phones, smart phones, portable computers, net books, tablets, and using a plurality of connectivity including but not limited to wireless, WiFi, internet connectivity; (2) means for downloading to a plurality of electronic devices, a program and user interface (UI) (“App”) to enable the electronic devices to connect to an automated negotiation and bargaining system; (3) means for accessing and connecting to an automated negotiation and bargaining system using any mode of connectivity including wireless, WiFi and internet or similar connectivity; (4) means for identifying and confirming any specific merchandize or merchandizes a buyer desires to purchase, including but not limited to retail goods, entrance to entertainment events and sporting and recreational events, through a sequence of one or more interactions with the bidding servers; (5) means for entering an offer price for the above-mentioned merchandize by the buyer; (6) means for responding with an acceptable price by a seller, as identified by the system; (7) means or going through one or more rounds of offer by the buyer and response by the seller until an acceptable price is established; (8) means for accepting and confirming by the buyer the offer price; and (9) means for completing the payment and execute the transaction via secured connectivity obtained by the buyer, a plurality of codes, including but not limited to one time use only bar codes, letters or numbers or combination, to be shown to the retail vendor, such as checkout counter, in exchange for the goods and/or services.

In still yet another preferred embodiment, there is provided a system to facilitate automate real time price negotiation and bargaining followed by actual purchase of merchandize or service at a retail location; wherein the merchandize can range from real goods available at any store or retail outlet to entertainment such as movies, concerts, sporting events and others. The system generally includes (1) means for using a plurality of electronic devices, including but not limited to desktop computers, laptops, net books, tablets and using a plurality of connectivity including but not limited to wired or wireless internet connection, to download, to a plurality of electronic devices, a program and user interface (UI) to enable the electronic devices to connect to an automated negotiation and bargaining system; (2) means for accessing and connecting the electronic devices using the UI to an automated negotiation and bargaining system; (3) means for identifying and confirming any specific merchandize or merchandizes a buyer desires to purchase, including but not limited to retail goods, entrance to entertainment events and sporting and recreational events, through a sequence of one or more interactions with the bidding servers; (4) means for entering an offer price for the above merchandize/s by the buyer; (5) means for responding with an acceptable price by the seller, as identified by the system; (6) means for going through one or more rounds of offer by the buyer and response by the seller until an acceptable price is established; (7) means for accepting and confirming by the buyer the offer price; and (8) means for completing the payment and executing the transaction via secured connectivity obtained by the buyer, a plurality of codes, including but not limited to one time use only bar codes, letters or numbers or combination, to be shown to the retail vendor, such as checkout counter, in exchange for the goods and/or services.

In yet another preferred embodiment, there is provided a system to facilitate automate real time price negotiation and bargaining followed by actual purchase of merchandize or service at a retail location; wherein the merchandize can range from real goods available at any store or retail outlet to entertainment such as movies, concerts, sporting events and others; the system generally including: (1) means for using a plurality telephonic devices, including but not limited telephones, mobile phones to dial and connect the telephone using voice-recognition and/or touch button to an automated negotiation and bargaining system; (2) means for identifying and confirming any specific merchandize or merchandizes a buyer desires to purchase, including but not limited to retail goods, entrance to entertainment events and sporting and recreational events, through a series of interactive commands and/or voice-recognition; (3) means for entering an offer price for the above-mentioned merchandize by a buyer; (4) means for responding with an acceptable price by a seller, as identified by the system; (5) means for going through one or more rounds of offer by buyer and response by the seller until an acceptable price is established; (6) means for accepting and confirming by the buyer the offer price; and (7) means for completing the payment and execute the transaction via secured connectivity obtained, by the buyer, a plurality of codes, including but not limited to letters or numbers or combination, to be shown to the retail vendor, such as checkout counter, in exchange for the goods and/or services.

### BRIEF DESCRIPTION OF THE DRAWINGS

The above mentioned features and steps of the invention and the manner of attaining them will become apparent, and the invention itself will be best understood by reference to the following description of the preferred embodiment(s) of the invention in conjunction with the accompanying drawings wherein:

FIG. 1 is a diagrammatic illustration of a system for automated real-time negotiation and bargaining followed by actual purchase;

FIG. 2 is a flow chart for facilitating the automated real-time negotiation and bargaining followed by actual purchase of merchandize, such as concert tickets;

FIG. 3 is a diagrammatic block diagram for automated real time negotiation and bargaining followed by actual purchase of merchandize, such as concert tickets;

FIG. 4 is a diagrammatic block diagram of a system, including hardware and connectivity, for automated real-time negotiation and bargaining followed by actual purchase of merchandize, such as concert tickets; and

FIG. 5 is a diagrammatic illustration of integration with a virtual retailer for automated real-time negotiation and bargaining followed by an actual purchase.

### DETAILED DESCRIPTION OF THE PREFERRED EMBODIMENTS

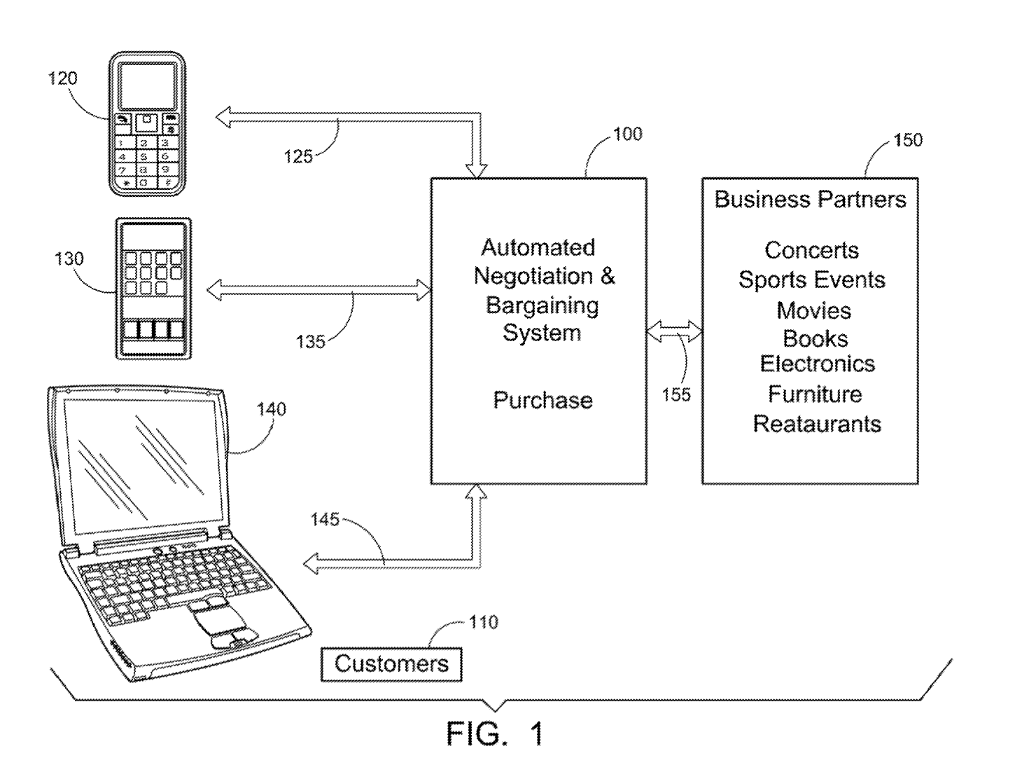

Referring now to the drawings and the detailed description that follows, there is illustrated in FIG. 1, a method and system for automated real time negotiation and bargaining followed by actual purchase. In this invention, a system 100, inclusive of hardware and software, is developed, as shown, to automate the merchandize identification, facilitate real-time price negotiation and bargaining followed by actual purchase. The hardware of system 100 might consist of a computer or computer cluster, where the computer cluster, for example, may comprise of several blades each containing multi-core CPU and appropriate memory and storage, optimally configured for multi-threading.

In one preferred embodiment, the customers have a method 110 to access this system 100 in real time using multitudes of devices, including but not limited to, normal phones 120 with text messaging service, smart phones 130 with internet access and systems 140 like laptops, netbooks, tablets, personal computers, etc., with internet access.

Further, in one embodiment, the customers using smart phones 130 with internet data service will use website or smart phone application, as shown by step 135, to communicate with system 100 for real time merchandize identification, price negotiation and bargaining followed by actual purchase. This communication is done by XML (extension markup language) queries and results.

Further, in one embodiment, the customers using systems 140 like laptops, netbooks, tablets, personal computers, etc. with internet access will use website or software application, as shown by step 145, to communicate with system 100 for real time merchandize identification, price negotiation and bargaining followed by actual purchase. This communication is done by XML (extension markup language) queries and results.

In one embodiment, the merchandise identification can be done by text description of product or service, bar code or some unique number, or actual picture. In this preferred embodiment the system 100 will process this information to uniquely identify the customer request.

Further, in one embodiment, the method and system tie-up with business partners 150 who either sell the merchandise or who provide services. These multitudes of business partners can include but not limited to, concerts, sports, movie theatres, amusement parks, or other events organizers, retail stores, book stores, electronic stores, furniture stores, restaurants, etc. The system 100 will communicate with business partners 150 by step 155 to get regular update about different merchandise/services like description, its availability, current price, allowed minimum price etc. Once the customer 110 completes the purchase, the sale information will also be communicated to business partner 150.

Further, in one embodiment, the system 100 will have multiple modules catering to different category of merchandises or services. They will share the same design and implementation architecture but some specifics will vary based on nature of merchandise or service or entertainment activity or others.

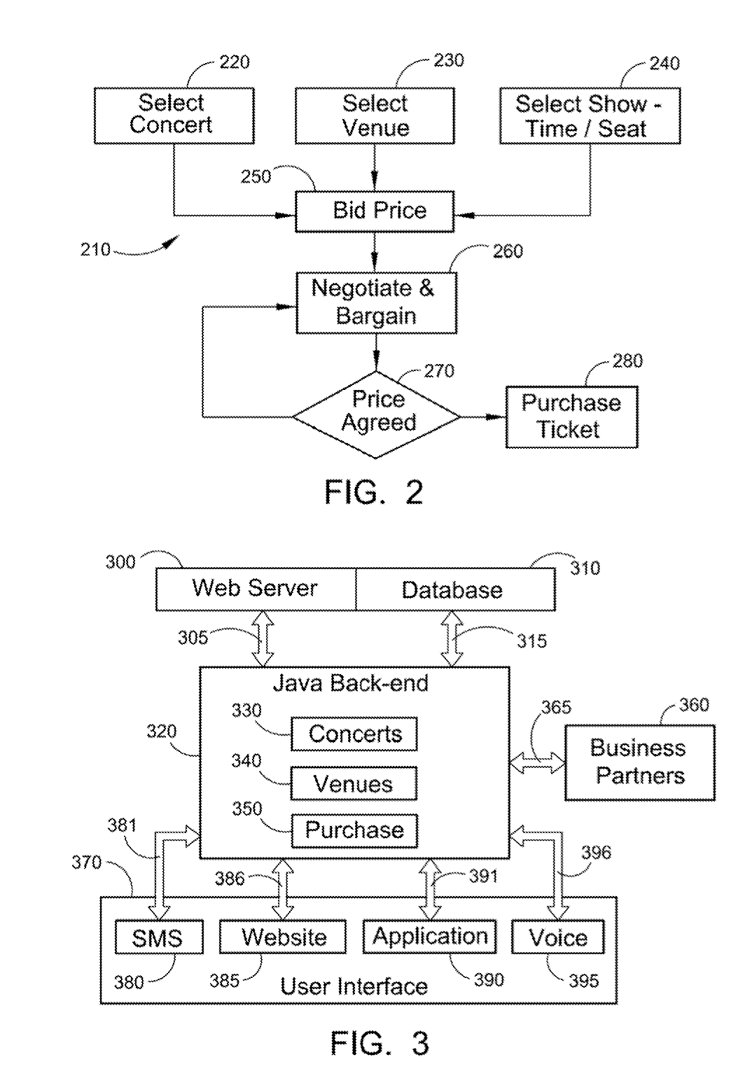

Further, in one embodiment, FIG. 2 illustrates a flow chart 210 for automated real time negotiation and bargaining followed by actual purchase of concert tickets.

In this implementation user will first select a concert 220, a venue 230 and a show time 240, in any order. The user will also have an option to select the seat. At a step 250, the user will bid the price for concert ticket. The invention at a step 260 will automate the concert ticket price negotiation and bargaining and interact with user to provide a price acceptable to the seller. If the user is not happy with the price, the user at a step 270 can update the offer price and continue the bargaining process. When user agrees with an updated ticket price, user at a step 280 will initiate the ticket(s) purchase and the system will complete the actual purchase transaction. Similar implementation will be done for other merchandise or services. In short then, the user, who is considered a willing buyer and the method implemented within the system which is considered the willing seller, begin an iterative bargaining process to identify what the willing buyer expects from the willing seller and what a willing seller expects from the willing buyer. Once the parties have bargained and negotiated back and forth and reached an agreement, the system and method executes a completed transaction in response to the willing buyer and the willing seller reaching an agreement upon what each one of them expects from the other.

Further, in one embodiment, FIG. 3 illustrates the implementation block diagram for automated real time negotiation and bargaining followed by actual purchase of concert tickets.

In one embodiment, a web server 300 will be installed and it will be used to develop the web contents. This will be used to implement XML queries.

Further, in one embodiment, a database 310 will be implemented to store the real time updates about concerts, venues, show times, seating arrangement, price for different categories of seating arrangement, available seats and discounts, etc. In concerts the ticket prices can be dependent on how close one sits to the stage. The database will have information about seating arrangements, available seat in each category, ticket pricing of each category and different permissible discount for each seating category. For example the front seat in a concert may be priced for $200 while back seats are priced for $30. The concert organizer may set different bidding methods for front seats and back seats.

This invention will enable the business partner, concert organizer in this implementation example, to control the bargaining, and final purchase price, at very fine granularity.

In one embodiment, a database table will be implemented to store information about multiple users, their identification numbers, emails, passwords and names.

In another embodiment, a database table will be implemented to store information about concerts, and each of the concert's unique identification number, artist name(s), duration, description, and reviews, etc.

In another embodiment, a database table will be implemented to store information about different venues, the unique identification number of each venue, street address, city, zip code and phone etc.

In another embodiment, a database table will be implemented to store information about concerts show-time and seating arrangement. It will consist of concert venue's unique identification number, concert identification number, and for each performance date the show time, normal ticket price based on seating arrangement and corresponding minimum discount.

In another embodiment, a database table will be implemented to store information about credit card that will be accessed, if required it will be updated, whenever a user completes a purchase transaction. It will consist of a user identification number; a system generated unique identification number for credit card, credit card details and billing address.

In another embodiment, a database table will be implemented to store information about purchase transactions. It will consist of a purchase reference number; system generated unique identification number for credit card, concert identification number, venue identification number, date and time of purchase, concert date and show time, seat, selling price and commission.

These database tables are critical for automating the negotiation and bargaining process and completing the purchase transactions.

In one embodiment, a backend system 320 will be developed using Java language. It will use step 305 to communicate with web server and use step 315 to access or update different database tables. In this system three main classes will be implemented—namely Concerts class 330, Venues class 340 and Purchase class 350.

The backend system 320 will communicate with multitude of business partners 360, concert organizing system, by step 365 to regularly update the database and web contents. When the user specifies the concert, venue and show time, as explained in FIG. 2, the backend system 320 will identify the corresponding business partner and work real time to determine concert ticket availability, manage price bargaining process and finally communicate purchase transaction. The backend 320 and step 365 will be customized based on each business partner's requirements. There is one single backend system working simultaneously with multitudes of business partners.

In one embodiment, the Concerts class 330 will have an application programming interface (API). Such APIs, application programming interface often referred as function, procedure or method, to identify the concert based on user's specified information, access concert details like artist(s), duration, descriptions etc.

In one embodiment, the Venues class 340 will have APIs to facilitate the user to select the venue, date and show time, negotiate and bargain the ticket price and complete the purchase transactions. The purchase transaction will be managed by Purchase class 350 that will implement APIs to automate the real time negotiation and bargaining followed by actual purchase. It will also communicate the purchase transactions to the business partners.

Further, in one embodiment, multitude of user interfaces 370 are developed that enable the end users to access the method, system and computer program for automated real time negotiation and bargaining followed by actual purchase. These multitudes of interfaces include, but are not limited to, short message service (SMS), internet website, computer or smart device application, and voice system.

Further, in one embodiment, SMS interface 380 is implemented. This interface will be simple text based communication between user and the implemented system that automates real time negotiation and bargaining followed by actual purchase of movie tickets. This interface will communicate with the backend by step 381.

In one example, user will type the following to specify movie, time and price—“c American Dream Tour San Francisco VIP $50”. The SMS interface 380 will parse this text interpret the concert name ‘American Dream Tour’, performing in San Francisco and user is interested to buy VIP seat at price of $50. It will communicate all this information to back-end by step 385. The Concerts, Venues and Purchase class will be used to get the relevant database value and the system will start the ticket price negotiation. The system will find the list price of VIP ticket as $75 dollar so it will initiate the bargaining process. The seller and automated bargaining system may decide to give the best price as $60. User will receive SMS reply as “price $60”. User may accept this price and decide to buy and send the message “p 2” so system will complete purchase transactions for two tickets and send a unique reference number “ref 2 ticket 12034831 date: time”; where the “date: time” is the time stamp when ticket was purchased. The user will show this information at concert's ticket counter and receive two VIP tickets.

The SMS interface 380 and its communication with backend by step 381 will be fault tolerant and intelligently handle miss-spelling and other errors. It will be smart to detect user's intent, guide and lead to fast real time negotiation and bargaining followed by actual purchase of movie tickets.

Further, in one embodiment, a website 385 is implemented. This interface will have multiple implementations based on access device and method used by customer. In one embodiment, it will be implemented as normal website that can be used by multitudes of devices like laptops, netbooks, tablets, personal computers, smart phones, etc with internet access.

The web interface 385 will be an intelligent system enabling the selection of concert, venue and show time selection for end user, and automate the real-time ticket price negotiation and bargaining followed by actual purchase. At the end of purchase, the user will have the option to print the actual transaction information or else receive a barcode image that can be scanned at concert's ticket counter or else receive some purchase reference number that can be used at concert venue ticket counter. The web interface will communicate by step 386 to fetch or retrieve concert information, user's selection, price negotiation, actual purchase and final delivery.

In another embodiment, multitudes of software applications 390 will be developed that would be installed on devices like laptops, netbooks, tablets, personal computers, etc. with internet access. In another embodiment, the software application implementation will be customized for smart phones. All these implementations will communicate with back-end server by step 391 to fetch or retrieve concert information, user's selection, price negotiation, actual purchase and final delivery.

There are multiple implementations, or access methods, in 385 and 390 but the usage flow, look and feel for all these methods will remain consistent such that user can opt for any method—be it website, software or smart phone application etc and easily select concert, venue and show time, negotiate ticket price, bargain and complete the actual purchase followed by ticket delivery.

Further, in another embodiment, a voice interface 395 is implemented that end-users can access using a plurality of telephonic devices, including but not limited to telephones, mobile phones, voice over internet, to access the automated real time negotiation and bargaining followed by actual purchase. User will use voice or touch buttons to utilize this interface and it will communicate with backend by step 396 to fetch or retrieve movie information, user's selection, price negotiation, actual purchase and final delivery.

The interface 395 can be implemented using voice recognition system or actual live persons to let the end user select movie, theatre and time, negotiate ticket price, bargain and complete the actual purchase followed by ticket delivery.

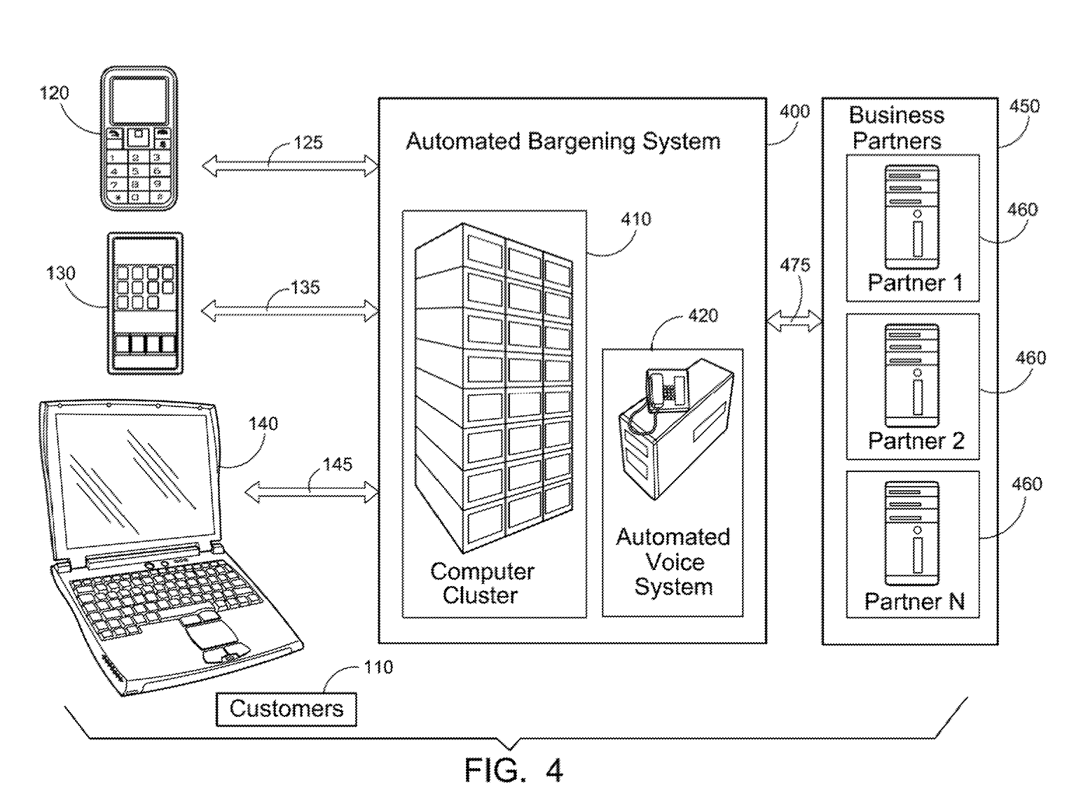

Further, in another embodiment, FIG. 4 illustrates the hardware installation for automated real time negotiation and bargaining followed by actual purchase of concert tickets. As explained earlier in FIG. 1 the customers 110 have multitudes of devices, including but not limited to, normal phones 120 with text messaging service, smart phones 130 with internet access and systems 140 like laptops, netbooks, tablets, personal computers, etc., with internet access to communicate with automated bargaining system 400 by step 125, 135, and 145 respectively for real time merchandize identification, price negotiation and bargaining followed by actual purchase.

In one embodiment, the automated bargaining system 400 will consist of computer cluster 410 and automated voice system 420. The computer cluster 410 could be multiple server-type computers connected together and work as one big system. For example, the cluster 410 may comprise of several server blades each containing multi-core CPU and appropriate memory and storage, optimally configured for multi-threading. The implementation, as illustrated in FIG. 3, will be installed in this computer cluster. Within the cluster there will be separate dedicated storage and computers for database, back-end and multiple user interfaces. This installation will be geared for excellence in performance and would be scalable to manage millions of transactions occurring in the same time.

In another embodiment, an automated voice system 420 will be installed that will have intelligent information system to guide the users accessing automated bargaining system by voice. This system will interpret what users are specifying, by voice or pressing touch buttons, and guide them in the process of specifying the concert, venue, show time, seat preference, real time ticket price bargaining and complete the actual ticket purchase.

In another embodiment, the automated bargaining system 400 will be connected to multiple of business partners 450 by step 475. There will be multiple business partners managing different concerts. For example partner 1 is managing the American tour of rock star Ms. A, whereas partner 2 is managing the Japanese jazz tour of artist Mr. B, and so on. Each business partner will have information about their respective concerts and the information will be accessible from different computer installations as illustrated by 460. All these computers of multiple business partners will work coherently with the automated bargaining system 400 to enable real time negotiation and bargaining followed by actual purchase of concert tickets.

Further, in another embodiment, the system will be enhanced or similar systems will be developed for other entertainment activities like sports events, concerts, theatre and amusement parks, etc. The database, user interface and the information exchange with business partners will be customized according to business needs of each entertainment activity.

In another embodiment, similar system will be developed for purchase of retail goods in each of the retail business verticals, including books, electronics, appliances, toys, clothing, furniture, etc. The database, interface and the information exchange with business partners will be customized according to the needs of each business verticals.

The present invention as heretofore described is useful wherever a monetary transaction happens between buyer(s) and seller(s). For example, such monetary transactions would include, but are not limited to transactions which occur in restaurants, hotels, seats for transportation and others. The present invention therefore, provides several unique and novel advantages, which can be summarized as follows:

When a buyer at a retail stores want to get the best bargain for the goods or services desired, the buyer may be very hesitant and shy to ask for a discount. The present invention allows the buyer to seek such a discount without asking a sales person. That is, a unique bargaining process is automated by the present invention, through the use of portable, wireless devices such as mobile phones, smart phones, and note pads, etc. and computers and laptops. In this regard, the buyer does not need to do a face to face negotiation with the “sales person”; instead the buyer by using the present invention can let their mobile device or telephone do the work of the negotiations.

The present invention also allows the customer to do their bargaining with (1) just text messages; or (2) through a mobile browser interface or through the internet; or (3) via a telephone, using voice recognition or touch pads to confirm a negotiated deal and then to proceed directly to check out. Such a negotiated process, at the customers choice, can take place at a retail outlet store itself or remotely.

The present invention provides a total framework including a method, system and hardware setup with software to accomplish the above is described negotiated transaction(s). The software in this case, can be downloaded by the customer or provided to the customer on a user selected computer readable medium, such as CD or DVD media.

Using the methodology as taught by the present invention, buyers and sellers can, in real-time, converge on the right price, providing a “win-win” for both of the involved parties. This type of automated bargaining is not just for retail shopping only but is equally applicable to get the best prices for entertainment and other services.

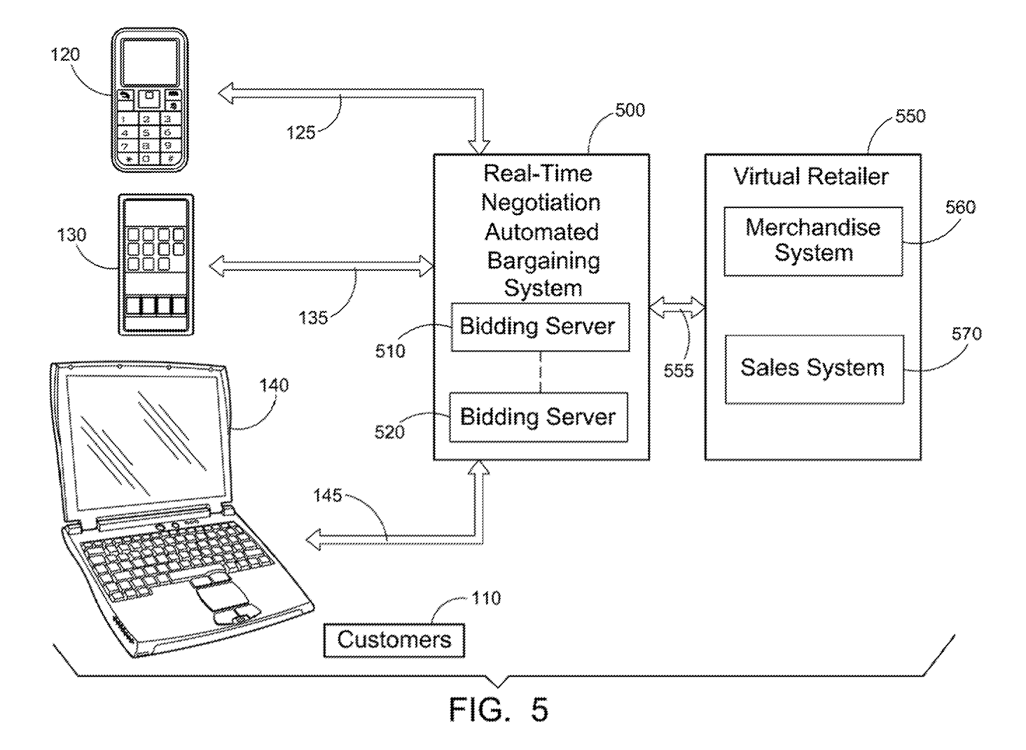

Referring now to the drawings and more particularly to FIG. 5, there is shown a system, and method which integrates a “virtual retailer” to enable a consumer or customer C to do electronic commerce (e-commerce) bargained transaction with an automated real time negotiation and bargaining system 500 followed by an actual purchase once an accepted price is established. In this invention, a system 500, inclusive of hardware and software, is developed, as shown, to automate the merchandize identification, facilitate real-time price negotiation and bargaining followed by actual purchase. A “virtual retailer” as described herein is a virtual site that obtains inventory passed from several internet retailers to the “virtual” site for disposition. An internet based retailer in this sense then is an entity who does e-commerce, such as Amazon.com, Buy.com, etc.

Further in one embodiment the automated bargaining system 500 is integrated with the virtual retailer system 550 by step 555. The system 500 will mainly integrate with merchandise system 560 and sale system 570 by step 555.

In one preferred embodiment, the merchandise system 560 will identify what merchandise can be sold by automated bargaining system and communicate related information like merchandise image, detail description, inventory, minimum acceptable price, list price etc. The automated bargaining system will integrate this information to present it to customers.

In one preferred embodiment, as described earlier, the customers have a method 110 to access this system 500 in real time using multitudes of devices, including but not limited to, normal phones 120 with text messaging service, smart phones 130 with internet access and systems 140 like laptops, netbooks, tablets, personal computers, etc., with internet access.

The customers will interact with the automated bargaining system 500 for real-time price negotiation and bargaining followed by actual purchase. Once the customer has accepted the selling price the purchase transaction will be completed by communicating the purchase information to a sale system 570 in virtual retailer system 550 by step 555. The merchandise will then be shipped to the consumer by the virtual retailer merchandise system 560.

Considering the negotiation and bargaining method in greater detail, the method for real-time negotiating and bargaining for the purchase of merchandize from an internet-based retailer, generally includes the following steps: first an electronic communication channel is established between the customer (C) and the internet-based retailer (e.g. the virtual retailer 550) via an automated negotiation and bargaining system 500. Next via a sequence of one or more interactions with at least one bidding server forming part of said automated negotiation and bargaining system 500, such as bidding servers 510 and 520 for example an item desired to be purchased by the buyer is identified. The sequence of one or more interactions includes the customer or buyer (C) entering via his or her electronic device, such as the electronic devices 120, 130, or 130 for example, an offer price for the identified item desired to be purchased; the virtual retailer 550 via the automated negotiation and bargaining system 500 responds to the offer price from the buyer (C) with an acceptable price via said at least one bidding server. This acceptable price may or may not be the offer price submitted by the buyer (C). If the price is different from the offer price made by the buyer, the above-mentioned steps are repeated. That is the steps of entering and responding continue until either an acceptable offer price is established or until the customer terminates the transaction by not entering another offer price. Once an acceptable offer price is established between the customer (C) and the virtual retailer 550, the process continues by executing a completed transaction for the purchase of the at least one item the buyer desires to purchase based upon an accepted offer price. In short then, the present invention enables a buyer (C) and a seller to “haggle” over the price that the buyer (C) desires to purchase and that the seller desires to sell.

When the buyer (C) desires to close the transaction by executing a completed transaction, the buyer (C) may use his or her electronic device to make payment via a credit card, a debit card or gift card. Alternately, the buyer C) may, when he or she arrives at the merchandize outlet or venue location may pay for the purchased item using cash or check. Other forms of payment are also contemplated within the true scope of the invention. For example, when the buyer (C) is using a smart phone with a near-field chip (NFC) or some form of RFID chip, payment may be made using these avenues. Alternatively, a retailer at check out may have a smart phone which will recognize the smart phone of the buyer (C) and thus, the transaction may be completed in this manner.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

We claim:

1. A method for real-time, electronic negotiating and bargaining, comprising the steps of:
bargaining iteratively to identify what a willing buyer expects from a willing seller and what a willing seller expects from a willing buyer; and
executing a completed transaction in response to the willing buyer and the willing seller reaching a negotiated agreement upon what each one of them expects from the other.

2. The method for real-time, electronic negotiating and bargaining, according to claim 1, wherein said willing seller is an internet based retailer.

3. The method for real-time, electronic negotiating and bargaining, according to claim 1, wherein said willing seller is a virtual retailer.

4. The method for real-time, electronic negotiating and bargaining, according to claim 1, wherein said willing seller is a local retailer.

5. The method for real-time negotiating and bargaining according to claim 1, wherein said willing seller is a remote retailer.

6. The method for real-time, electronic negotiating and bargaining, according claim 1, wherein said willing seller is selected by the willing buyer from a group of willing sellers including: an internet based retailer; a virtual retailer; a local retailer and a remote retailer.

7. The method for real-time, electronic negotiating and bargaining, according claim 6, wherein said step of bargaining iteratively includes the steps of:
establishing an electronic communication channel between the willing buyer and the willing seller via an automated negotiation and bargaining system;
identifying at least one item the willing buyer desires to purchase via a sequence of one or more interactions with at least one bidding server forming part of said automated negotiation and bargaining system; and
wherein said sequence of one or more interactions includes:
entering an offer price for the identified item desired to be purchased by the willing buyer;
responding to said offer price with an acceptable price via said at least one bidding server; and
repeating said steps of entering and responding until an acceptable offer price is established; and
accepting an offer price presented by the buyer to facilitate completing a transaction between the willing buyer and the willing seller.

8. The method for real-time, electronic negotiating and bargaining, according claim 7, wherein said step of establishing includes the steps of:
using at least one mode of connectivity to facilitate communication with an automated negotiation and bargaining system; and
using at least one communication device to access and connect to said automated negotiation and bargaining system.

9. The method for real-time, electronic negotiating and bargaining, according claim 8, wherein said step of using at least one mode of connectivity includes: using wireless connectivity; using internet connectivity; using WiFi connectivity and/or using any mode of connectivity means.

10. The method for real-time, electronic negotiating and bargaining, according claim 9, wherein said step of using at least one communication device includes: using cell phones, using mobile phones, using smart-phones, using laptop personal computers, using tablets, using land telephones, using computers, using voice-recognition devices, using touch button communication devices and/or using communication device means.

11. The method for real-time, electronic negotiating and bargaining, according claim 10, wherein said step of identifying at least one item the willing buyer desires to purchase include the steps of:
confirming the willing buyer desires to purchase the identified item using the acceptable offer price; and
wherein the identified item includes: merchandize, retail goods, retail services, food items, entrance to entertainment events; entrance to sporting events, entrance to recreational events, and/or any combination thereof.

12. The method for real-time, electronic negotiating and bargaining, according to claim 1, wherein said step of executing a completed transaction includes:
completing a payment transaction; and
sending the willing buyer confirmation on shipment or pickup of the identified item.

13. The method for real-time, electronic negotiation and bargaining, according to claim 12, wherein confirmation on shipment is received from an internet based retailer.

14. The method for real-time, electronic negotiation and bargaining, according to claim 12, wherein confirmation on shipment is received from a virtual retailer.

15. The method for real-time, electronic negotiating and bargaining, according claim 1, wherein said step of executing a completed transaction includes:
completing a payment transaction; and
providing the willing buyer with at least one redemption code to be shown in exchange for retail pickup of the identified item.

16. The method for real-time, electronic negotiating and bargaining, according claim 15, wherein said at least one redemption code includes: a one-time-use only bar codes, letters or numbers or combination thereof and redemption code means.

17. The method for real-time, electronic negotiating and bargaining, according claim 15, wherein each real-time transaction takes place at or near a merchandizing center where the purchased identified item is available for pick-up by the buyer.

18. The method for real-time, electronic negotiating and bargaining, according claim 7, wherein said sequence of one or more interactions between the willing buyer and the at least one bidder server takes place at a physical location selected by the willing buyer;
and wherein said physical location includes: a residence of the buyer; a merchandizing center, a retail store, a sporting event venue, an entertainment event venue, or a recreational event venue.

19. The method for real-time, electronic negotiating and bargaining, according claim 7, further comprising the steps of:
downloading to said at least one communication device, an APP, said APP including a program and user interface to enable said at least one communication device to connect and access said automated negotiation and bargaining system.

20. A real-time negotiating and bargaining system, comprising:
means for haggling iteratively to identify what a willing buyer expects from a willing seller and what a willing seller expects from a willing buyer; and
means for executing a completed transaction in response to the willing buyer and the willing seller reaching agreement upon what each one of them expects from the other.

21. A real-time negotiating and bargaining system according to claim 20, further comprising:
means for establishing an electronic communication channel between a buyer and seller of merchandize via an automated negotiation and bargaining system;
means for identifying at least one item a buyer desires to purchase via a sequence of one or more interactions with at least one bidding server forming part of said automated negotiation and bargaining system; and
means for entering an offer price for the identified item desired to be purchased by the willing buyer;
means for responding to said offer price with an acceptable price via said at least one bidding server;
means for entering and responding until an acceptable offer price is established; and
means for accepting an offer price presented by the buyer.

22. The real-time negotiating and bargaining system according to claim 21, wherein said means for establishing includes:
means for using at least one mode of connectivity to facilitate communication with an automated negotiation and bargaining system; and
means for using at least one communication device to access and connect to said automated negotiation and bargaining system.

23. The real-time negotiating and bargaining system according to claim 22, wherein said means for using at least one mode of connectivity includes: means for using wireless connectivity; means for using internet connectivity; means for using WiFi connectivity and/or means for using any mode of connectivity means.

24. The real-time negotiating and bargaining system according to claim 22, wherein said means for using at least one communication device includes: means for using cell phones, means for using mobile phones, means for using smart-phones, means for using laptop personal computers, means for using tablets, means for using land telephones, means for using computers, means for using voice-recognition devices, means for using touch button communication devices and/or means for using communication device means.

25. The real-time negotiating and bargaining system according to claim 21, wherein said means for identifying at least one item the willing buyer desires to purchase includes:
means for confirming the buyer desires to purchase the identified item using the accepted offer price; and
wherein the identified item includes: merchandize, retail goods, food items, entrance to entertainment events; entrance to sporting events, entrance to recreational events, and/or any combination thereof.

26. The real-time negotiating and bargaining system according to claim 20, wherein means for executing a completed transaction includes:
means for completing a payment transaction; and
means for providing the buyer with at least one redemption code to be shown to a retail vendor in exchange for the identified item.

27. The real-time negotiating and bargaining system according to claim 26, wherein means for executing a completed transaction includes:
means for completing a payment transaction; and
means for sending the willing buyer confirmation on shipment or pickup of the identified item.

28. The real-time negotiating and bargaining system according to claim 27, wherein confirmation on shipment is received from an internet based retailer.

29. The real-time negotiating and bargaining system according to claim 27, wherein confirmation on shipment is received from a virtual retailer.

30. The real-time negotiating and bargaining system according to claim 26, wherein said at least one redemption code includes: a one-time-use only bar codes, letters or numbers or combination thereof and redemption code means.

31. The real-time negotiating and bargaining system according to claim 26, wherein each real-time transaction takes place at or near a merchandizing center where the purchased item is available for pick-up by the buyer.

32. The real-time negotiating and bargaining system according to claim 21, wherein said sequence of one or more interactions between the willing buyer and the at least one bidder server takes place at a physical location selected by the willing buyer;
and wherein said physical location includes: the residence of the willing buyer; the merchandizing center, a retail store, a sporting event venue, an entertainment event venue, or a recreational event venue.

33. The real-time negotiating and bargaining system according to claim 20, further comprising:
means for downloading to said at least one communication device, an APP, said APP including a program and user interface to enable said at least one communication device to connect and access said automated negotiation and bargaining system.
